(19) United States
(12) Patent Application Publication
(10) Pub. No.: US 2003/0056033 A1
(43) Pub. Date: Mar. 20, 2003

(54) Method of ensuring the integrity of a command instruction exchanged between a host device and an ATA device

(75) Inventors: Barry J. Debbins, Lancaster, NY (US); David A. Snell, Youngstown, NY (US)

Correspondence Address: Peter K. Sommer, Esq., Phillips, Lytle, Hitchcock, Blaine & Huber LLP, Intellectual Property Group, 3400 HSBC Center, Buffalo, NY, 14203, US

(73) Assignee: ATTO Technology, Inc.

(21) Appl. No.: 09/953,986

(22) Filed: Sep. 17, 2001

(51) Int. Cl. G06F 3/00

(52) U.S. Cl. 710/5

(57) ABSTRACT

The present invention provides an improved method of ensuring the integrity of command instructions exchanged between a host and an ATA device of an array of one or more ATA devices. The invention discloses a method of error detection for transfers of both control information and command information. The invention broadly includes the steps of: writing control information to one or more locations on the selected ATA device; reading the information stored at the corresponding locations; and comparing the control information to the information stored. Other aspects of the invention include writing command information to the ATA device; reading the information stored at the location to which the command information is written; and comparing the command information to the information stored. Other aspects of the invention terminate the command instruction if any compared information is not equal; or if the command instruction is not completed within a preset time interval.

### TECHNICAL FIELD

The present invention relates generally to computer systems, and, more particularly, to command instructions exchanged between a host system or device (e.g, a microprocessor-based personal computer, workstation, server, array controller, etc.) and an ATA device array consisting of one or more ATA devices (e.g., disk drives, CD-ROM drives, CD recorders, DVD drives, tape drives, removable floppy disk drives, etc.).

### BACKGROUND OF THE INVENTION

The proliferation of data-intensive computing applications has created an ever increasing demand for peripheral devices to reliably store significant amounts of information and provide timely access to stored data. Peripheral devices, such as disk drives, CD-ROM drives, CD recorders, DVD drives, removable floppy disk drives, tape drives and the like, are used in millions of computer systems worldwide. An interface connects such peripheral devices to the computer system. The choice of an interface can be a major factor in system performance.

The most common interface used to connect a disk drive to a host system is the ATA interface. An ATA interface is one which conforms to the industry-standard “AT Attachment” specification. An ATA device is a peripheral device connected to a host system or data bus through an ATA interface. The ATA interface is commonly referred to as an IDE (“Integrated Drive Electronics”) interface, and the terms are now used interchangeably. Many variations of the ATA interface have evolved during the last two decades including ATA/ATAPI, EIDE, ATA-2, Fast ATA, ATA-3, Ultra ATA, Ultra DMA, ATA-4, ATA-5, ATA/66 and others. While ATA interfaces have been used primarily in connection with disk drives, they are not so limited and are commonly used with each peripheral device listed above, and others.

Principal alternatives to the ATA interface are SCSI (“Small Computer System Interface”) and Fibre Channel interfaces. While the speed, capacity and reliability of ATA devices have increased significantly since their introduction in the mid-1980's, speed, adaptability and reliability are generally improved with SCSI and Fibre Channel interfaces. SCSI interfaces permit attachment of many peripheral devices to a single SCSI port and Fibre Channel interfaces allow many servers and storage devices to be interconnected into what is often referred to as a “storage area network” or SAN.

The principal disadvantage to such alternatives, however, is cost. The cost of SCSI and Fibre Channel devices and interfaces is often substantially greater. In addition, SCSI and Fibre Channel devices and interfaces produce significantly more heat and utilize more power. ATA devices can also provide higher density storage. Furthermore, various configurations of ATA devices, such as RAID (“Redundant Array of Inexpensive Disks”) arrays and JBOD (“Just a Bunch Of Disks”) arrays, have been developed to take advantage of the lower cost of ATA devices while providing high storage capacity and relatively fast data access. As used herein, an array of ATA devices means one or more ATA devices.

These improvements in ATA technology provide ATA devices with characteristics making them suitable for large-capacity, high-performance applications. Without the introduction of additional intelligence in an ATA device or an array of ATA devices, however, the minimal error detection capabilities inherent in ATA devices are often determined to be unsuitable for computer applications requiring high performance and reliability. Thus, many buyers turn to more expensive SCSI or Fibre Channel devices and interfaces.

The object of the present invention is to improve the reliability of ATA devices and ATA arrays. The method claimed ensures the integrity and reliability of command instructions exchanged between a host device or system and an array of one or more ATA devices by providing a method of detecting errors that may occur when control information is written to the registers of the ATA device.

A command instruction includes both control information and command information, referred to herein as the control portion and the command portion, respectively, of the command instruction. Prior to execution of any command, the control information corresponding to the command instruction is written to one or more of a series of ATA device registers resident in all ATA devices. A table of ATA registers follows:

| LOCATION | WRITE REGISTER | READ REGISTER |
|---|---|---|
| (CS0 = 0, CS1 = 1) | CONTROL BLOCK REGISTERS | |
| 6 | ALTERNATE STATUS | DEVICE CONTROL |
| 7 | DEVICE ADDRESS | NOT USED |
| (CS0 = 1, CS1 = 0) | COMMAND BLOCK REGISTERS | |
| 0 | DATA | DATA |
| 1 | FEATURES | ERROR |
| 2 | SECTOR COUNT | SECTOR COUNT |
| 3 | SECTOR NUMBER | SECTOR NUMBER |
| 4 | CYLINDER LOW | CYLINDER LOW |
| 5 | CYLINDER HIGH | CYLINDER HIGH |
| 6 | DEVICE/HEAD | DEVICE/HEAD |
| 7 | COMMAND | STATUS |

The writing of such control information to the ATA device registers is often referred to as a control transfer. Control transfers include tasks such as DEVICE/HEAD register initialization (i.e., selection of the desired peripheral device if the system includes more than one), logical block address initialization (i.e. selection of the location on the selected device to be acted upon), block count initialization (i.e. selecting the number of bytes, at the selected location, to be acted upon), writing of command information, and checking status information.

The particular control information that must be written for a given command instruction, and the register(s) to which that control information must be written, are defined in the standard AT Attachment specification. Each command instruction requires that one or more blocks of control information, referred to herein as control subportions, be written to one or more ATA device registers.

For example, a “read DMA queued” command requires that the command tag value subportion be written to the SECTOR COUNT register, and that the sector count subportion be written to the FEATURES register. A “read DMA” command requires that the sector count subportion be written to the SECTOR COUNT register, and does not require any that control information be written to the FEATURES register. Other examples of command instructions and the corresponding control information (or subportions) follow:

| COMMAND | CONTROL SUBPORTIONS | REGISTERS |
|---|---|---|
| SLEEP | E6 (SLEEP COMMAND | COMMAND |
| | OPERATION CODE) | |
| IDLE | TIME PERIOD VALUE | SECTOR COUNT |
| | E3 (IDLE COMMAND CODE) | COMMAND |
| SEEK | LOGICAL BLOCK ADDRESS BITS | SECTOR NUMBER |
| | 0-7 | |
| | LOGICAL BLOCK ADDRESS BITS | CYLINDER LOW |
| | 8-15 | |
| | LOGICAL BLOCK ADDRESS BITS | CYLINDER HIGH |
| | 16-23 | |
| | DEVICE ADDRESS AND | DEVICE/HEAD |
| | LOGICAL BLOCK ADDRESS BITS | |
| | 24-27 | |
| | 70 h | COMMAND |

ATA devices do not include error detection for control transfers. Other inventions disclose methods of error detection for data transfers to and from an ATA device. For example, U.S. Pat. No. 6,192,492 (Masiewicz et al.) discloses a method of implementing fast, reliable data transfers across a data bus between a host and a device in a computer system having a host processor, a peripheral device such as a hard disk drive and a data bus. Current ATA, SCSI and Fibre Channel technology provide error detection for data transfers, but only Fibre Channel and SCSI are believed to provide error detection for control transfers. Masiewicz et al. does not disclose a method of error detection for control transfers to ATA devices.

Therefore, a need exists for a method of error detection in a computer system which ensures the integrity and reliability of information exchanged in a control transfer from a host device or system to an ATA device of an array of one or more ATA devices.

### DISCLOSURE OF THE INVENTION

With parenthetical reference to the corresponding elements or portions of the disclosed embodiment, merely for purposes of illustration and not by way of limitation, the present invention provides an improved method of ensuring the integrity of command instructions exchanged between a host system or device and an ATA device (e.g., a disk drive) of an array of one or more ATA devices. The command instruction includes a control information portion (i.e. a control portion) and a command information portion (i.e. a command portion). The control portion consists of one or more control subportions.

The improved method broadly includes the following steps: writing a first control subportion to a first location on an ATA device; reading the information stored at the first location; and comparing the information read to the first control subportion.

Another aspect of the invention includes, in addition to the foregoing steps, the following additional steps: writing a second control subportion to a second location on an ATA device; reading the information stored at the second location; and comparing the information read to the second control subportion.

Yet another aspect of the invention includes, in addition to the foregoing steps, the following additional steps: writing a third control subportion to a third location on an ATA device; reading the information stored at the third location; and comparing the information read to the third control subportion.

In one aspect of the present invention, the device array includes a single ATA device. In another aspect, the device array includes a plurality of ATA devices.

The present invention in one aspect provides that the ATA device to be acted upon includes an ATA device register, and that the first location on the selected ATA device is an ATA device register. Other aspects of the invention are directed to an ATA device which includes a plurality of ATA device registers, where the locations written to and/or read from include a corresponding plurality of ATA device registers.

In one aspect of the present invention, the ATA device to be acted upon includes a CYLINDER HIGH register, CYLINDER LOW register, SECTOR NUMBER register, FEATURES register and SECTOR COUNT register, and the first location on the selected ATA device is one of those registers.

In other aspects of the invention, the ATA device to be acted upon includes a DEVICE/HEAD register, and the first location on the selected ATA device is the DEVICE/HEAD register.

In another aspect of the invention, the ATA device to be acted upon includes a CYLINDER HIGH register, CYLINDER LOW register, SECTOR NUMBER register, FEATURES register and SECTOR COUNT register, and the second location on the selected ATA device is one of those registers. In yet another aspect of the invention, the third location on the selected ATA device is another of those registers.

In other aspects of the present invention, the command portion of the command instruction is written to a second, third or fourth location on the selected ATA device, which begins execution of the command instruction. In another aspect, the ATA device to be acted upon includes a COMMAND register and the second location on the selected ATA device is the COMMAND register. In yet another aspect, the third location on the selected ATA device is the COMMAND register. In another, the fourth location on the selected ATA device is the COMMAND register.

In one aspect of the present invention, information is stored in two additional locations on the ATA device to be acted upon, and the information stored at those two locations are read and compared. In one aspect of the invention, the two additional locations are the third and fourth locations on the ATA device. In another aspect, the two additional locations are the fourth and fifth locations on the ATA device. In yet another aspect, the two additional locations are the fifth and sixth locations on the ATA device. Another aspect of the invention terminates the command instruction exchange if the information stored at the two additional locations is not equal. In another aspect, the ATA device to be acted upon includes a STATUS and an ALTERNATE STATUS register, and one of the additional locations is the STATUS register. In another, the other additional location is the ALTERNATE STATUS register.

In another aspect of the invention, the following steps are performed sequentially: the first control subportion is first written to the first location on the selected ATA device; then, the information stored at the first location is read; and then, the information read at the first location is compared with the first control subportion.

In another aspect of the invention, the following steps are first performed sequentially: the first control subportion is first written to the first location on the selected ATA device; then, the information stored at the first location is read; then, the information read at the first location is compared with the first control subportion; then, the following steps are performed without regard to sequence: writing a second control subportion to a second location on an ATA device; reading the information stored at the second location; and comparing the information read to the second control subportion.

In another aspect of the invention, the following steps are performed sequentially: the first control subportion is first written to the first location on the selected ATA device; then, the information stored at the first location is read; then, the information read at the first location is compared with the first control subportion; then, the second control subportion is written to the second location on the selected ATA device; then, the information stored at the second location is read; then, the information read at the second location is compared with the second control subportion.

In another aspect of the invention, the following steps are first performed: writing a first control subportion to a first location on an ATA device; reading the information stored at the first location; and comparing the information read to the first control subportion; then, the following steps are performed: writing a second control subportion to a second location on an ATA device; writing a third control subportion to a third location on an ATA device; reading the information stored at the second location; comparing the information read to the second control subportion; reading the information stored at the third location; and comparing the information read to the third control subportion.

In another aspect of the invention, the following steps are performed sequentially: the first control subportion is first written to the first location on the selected ATA device; then, the second control subportion is written to the second location on the selected ATA device; and then, the third control subportion is written to the third location on the selected ATA device; and wherein at least one of the first location and the second location is read before the third location is read.

In another aspect of the invention, the following steps are first performed: writing a second control subportion to a second location on an ATA device, and writing a third control subportion to a third location on an ATA device; and then, the following steps are performed: reading the information stored at the second location, and reading the information stored at the third location.

In one aspect of the invention, the location to which the last control subportion is written is not the first location read.

Another aspect of the invention is directed to a queued command instruction. In that aspect of the invention, the ATA device to be acted upon includes a FEATURES register and a SECTOR COUNT register, and the second location on the selected ATA device is the FEATURES register and the third location on the selected ATA device is the SECTOR COUNT register.

A further aspect of the present invention terminates the command instruction exchange if the first control subportion is not equal to the stored information with which it is compared. Another aspect of the present invention terminates the command instruction exchange if any control subportion is not equal to the corresponding stored information with which it is compared.

Another aspect of the present invention terminates the command instruction exchange if the execution of the command instruction is not completed within a preset time interval.

Other aspects of the present invention provide that the ATA device array includes one or more disk drives, CD-ROM drives, CD recorders, DVD drives, tape drives or removable floppy drives.

The general object of the invention is to improve the reliability and integrity of command instructions exchanged between a host system or device and an ATA device of an array of one or more ATA devices.

Another object of the invention is to provide error detection for transfers of control and command information from a host system or device to an ATA device of an array of one or more ATA devices.

Another object of the invention is to provide a method of ensuring that a control transfer results in the selection of the desired ATA device of a device array.

Another object of the invention is to provide a method of terminating a command instruction if any control information written to an ATA device register is actually or potentially unreliable.

Another object of the invention is to provide a method of terminating a command instruction if any command information written to an ATA device register is actually or potentially unreliable.

Another object of the invention is to provide a method of terminating a command instruction if execution of the command instruction is not completed within a preset time interval, thereby ensuring the integrity of the command instruction exchange.

These and other objects and advantages will become apparent from the foregoing and ongoing written specification, the accompanying drawings and the appended claims.

### BRIEF DESCRIPTION OF THE DRAWINGS

FIG. 1 is a block diagram depicting a computer system having a host device and an ATA device array.

FIG. 2 is a flowchart illustrating the operation of a preferred embodiment of the invention.

### DESCRIPTION OF THE PREFERRED EMBODIMENTS

At the outset, it should be clearly understood that like reference numerals are intended to identify the same parts, elements or portions consistently throughout the several drawing figures, as such parts, elements or portions may be further described or explained by the entire written specification, of which this detailed description is an integral part. Unless otherwise indicated, the drawings are intended to be read together with the specification, and are to be considered a portion of the entire written description of this invention.

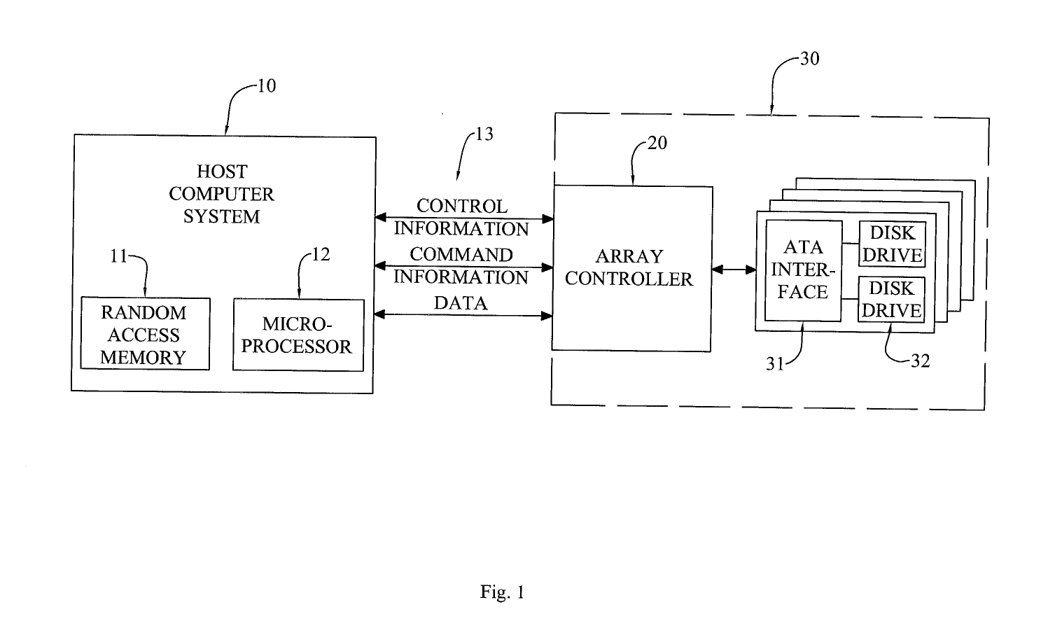

The computer system in the example of FIG. 1 includes a microprocessor-based personal computer 10 with a microprocessor 12 and random access memory 11, and an ATA device array 30 consisting of an array controller 20, and a plurality of ATA interfaces 31 and disk drives 32.

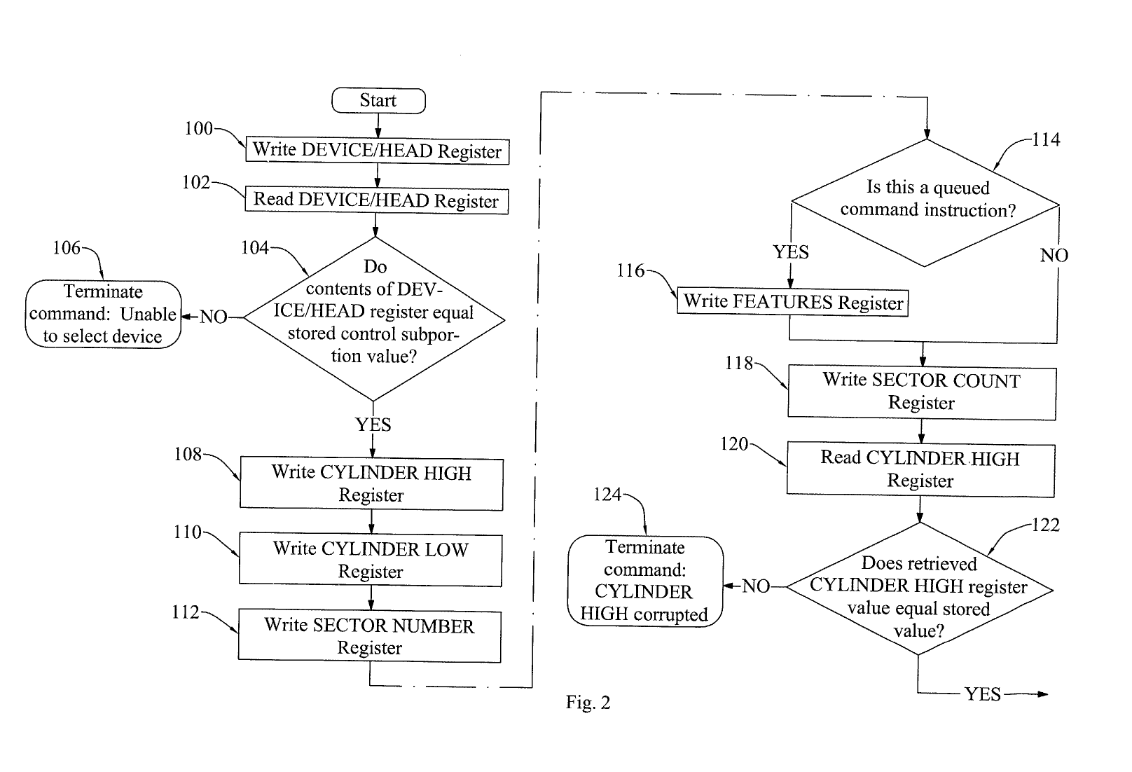

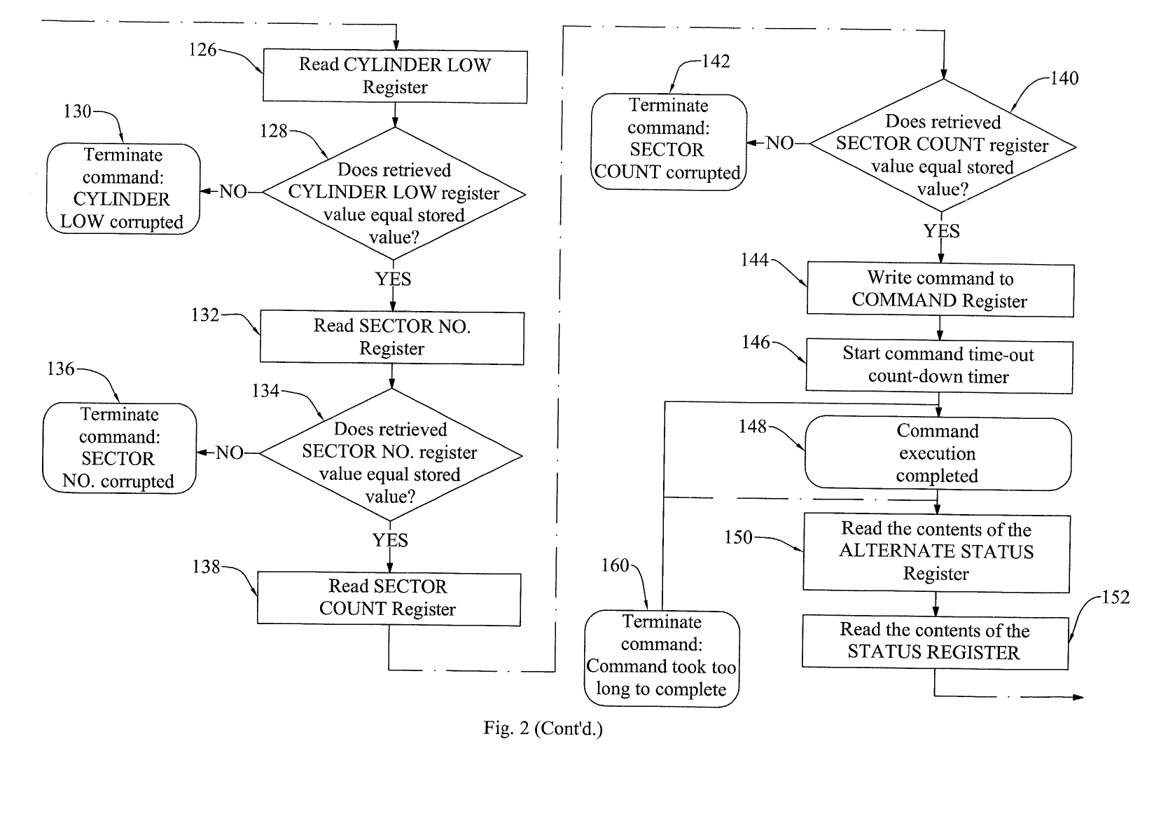

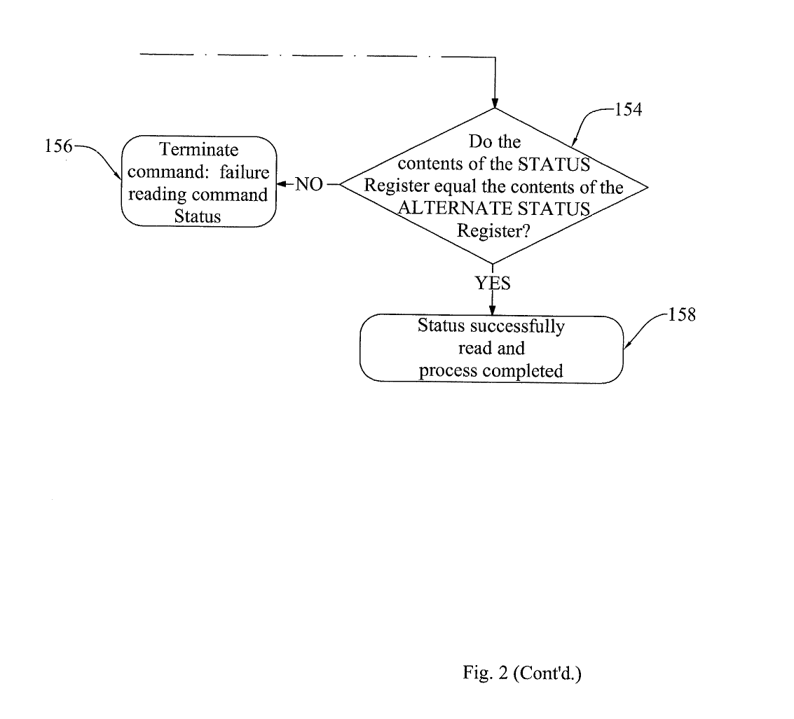

FIG. 2 is a flow chart depicting one illustrative embodiment of the invention. FIG. 2 illustrates the invention as applied to read DMA/write DMA and read DMA queued/write DMA queued command instructions. The process starts at block 100 wherein the host device writes a first control subportion to the DEVICE/HEAD register in the ATA device. Block 100 depicts the selection of the desired device on the ATA interface which will respond to subsequent writes to and reads from other ATA device registers.

Next, at block 102, the content of the DEVICE/HEAD register written to at block 100 is read. The process then passes to block 104 which depicts a determination of whether the value read from the DEVICE/HEAD register 102 is equal to the value designated to be written 100.

If a determination is made that the compared values are not equal (i.e. the output of block 104 is “NO”), it is uncertain whether the desired ATA device has been selected. In that case, the process passes to block 106 and the command instruction is terminated.

If a determination is made that the compared values are equal (i.e. the output of block 104 is “YES”), it is highly probable that the desired ATA device has been selected and that the desired device will respond to subsequent register reads and writes. In this case, the process passes to blocks 108, 110 and 112 where additional control subportions are written to the CYLINDER HIGH, CYLINDER LOW and SECTOR NUMBER registers in the selected ATA device.

The process then passes to block 114 which depicts a determination of whether the command instruction is a queued command. Command queuing allows the host to issue concurrent commands to the same ATA device, which are then processed, i.e., written to the COMMAND register on a first-in-first-out basis or, in some ATA devices, reordered for efficient execution and then written to the COMMAND register. If a determination is made that the command instruction is queued—for example, the command instruction is “read DMA queued” or “write DMA queued”—the process passes to block 116 where the host device writes an additional control subportion to the FEATURES register in the selected ATA device, and then passes to block 118 where the host device writes another control subportion to the SECTOR COUNT register in the selected ATA device. The invention writes to the FEATURES register only if the command instruction is queued.

If a determination is made at block 114 that the command instruction is not queued—for example, “read DMA” or “write DMA”—the process bypasses block 116 and passes directly to block 118, described above.

Not every step depicted at blocks 108 through 118 is performed for every command instruction. If the command instruction exchange is not terminated at block 106, upon selection of the ATA device, at least one of the steps depicted at blocks 108, 110, 112, 114, 116 and 118 will be performed for every command instruction. For some command instructions, all steps will be taken. The number of steps to be taken is determined by the command instruction to be executed. The invention recognizes the command instruction to be executed and validates only the corresponding control subportions.

In addition, the order of the steps depicted in blocks 108 through 118 is not significant. They may be performed in any order.

After one or more of the steps depicted in blocks 108 through 118 are performed, the process passes to blocks 120 through 142, where the contents of the registers written to in blocks 108 through 118 are read and compared. In block 120, the content of the CYLINDER HIGH register in the selected ATA device is read. Next, the process passes to block 122 which depicts a determination of whether the value read from the CYLINDER HIGH register 120 is equal to the value designated to be written 108.

If a determination is made that the compared values are not equal (i.e. the output of block 122 is “NO”), the integrity of the command instruction exchange is uncertain. In that case, the process passes to block 124 and the command instruction is terminated.

If a determination is made that the compared values are equal (i.e. the output of block 122 is “YES”), the process passes to block 126 where the content of the CYLINDER LOW register written at block 110 is read. Next, the process passes to block 128 which depicts a determination of whether the value read from the CYLINDER LOW register 126 is equal to the value designated to be written 110.

If a determination is made that the compared values are not equal (i.e. the output of block 128 is “NO”), the integrity of the command instruction exchange is uncertain. In that case, the process passes to block 130 and the command instruction is terminated.

If a determination is made that the compared values are equal (i.e. the output of block 128 is “YES”), the process passes to block 132 where the content of the SECTOR NUMBER register written to at block 112 is read. The process then passes to block 134 which depicts a determination of whether the value read from the SECTOR NUMBER register 132 is equal to the value designated to be written 112.

If a determination is made that the compared values are not equal (i.e. the output of block 134 is “NO”), the integrity of the command instruction exchange is uncertain. In that case, the process passes to block 136 and the command instruction is terminated.

If a determination is made that the compared values are equal (i.e. the output of block 134 is “YES”), the process passes to block 138 where the content of the SECTOR COUNT register written to at block 118 is read. The process then passes to block 140 which depicts a determination of whether the value read from the SECTOR COUNT register 138 is equal to the value designated to be written 118.

If a determination is made that the compared values are not equal (i.e. the output of block 140 is “NO”), the integrity of the command instruction exchange is uncertain. In that case, the process passes to block 142 and the command instruction is terminated.

If a determination is made that the compared values are equal (i.e. the output of block 140 is “YES”), the process passes to block 144 where the host device writes the command portion of the command instruction to the COMMAND register in the selected ATA device.

The order of the steps depicted at blocks 120 through 142 is not significant; provided, however, that the reads performed at blocks 120, 126, 132 or 138 must be performed before the corresponding comparisons are made at blocks 122, 128, 134 or 140.

Next, the process passes to block 146 which depicts the commencement of a preset time interval effectuated by a count-down timer. As reflected in block 160, initialization and execution of the command instruction is thereafter terminated if execution of the command instruction is not completed within the preset time interval.

Should the preset time interval commenced at block 146 not first expire, the process passes to block 148 which depicts the completion of the command execution process.

Should the preset timer interval commenced at block 146 not first expire, the process passes to block 150 wherein the contents of the ALTERNATE STATUS register in the selected ATA device is read, and to block 152 wherein the contents of the STATUS register in the selected ATA device is read. Upon completion of the command execution process 148, the STATUS register and ALTERNATE STATUS register each contain a one-bit error code. The one-bit error code in each register is set to “1” when execution of the command results in an error, and to “0” if the command instruction executes successfully. Both registers are read in this process to verify that the error code is read correctly, so as to avoid a false indication of successful completion of the command instruction.

Next, the process passes to block 154 which depicts a determination of whether the value read from the STATUS register 152 is equal to the value read from the ALTERNATE STATUS register 154. If a determination if made that the values are not equal (i.e. the output of block 154 is “NO”), the process passes to block 156 and the command instruction is terminated.

If a determination if made that the compared values are equal (i.e. the output of block 154 is “YES”), the process passes to block 158 which depicts the completion of the command instruction exchange.

While there has been described what is believed to be the preferred embodiment of the present invention, those skilled in the art will recognize that other and further changes and modifications may be made thereto without departing from the spirit of the invention. Therefore, the invention is not limited to the specific details and representative embodiments shown and described herein. Accordingly, various modifications may be made without departing from the spirit or scope of the general inventive concept as defined and differentiated by the following claims.

What is claimed is:

1. A method of ensuring the integrity of a command instruction exchanged between a host a system or device and an ATA device of a device array, said command instruction comprising a control portion having one or more control subportions and a command portion, comprising the steps of:
(a) writing a first control subportion to a first location on said device;
(b) reading the information stored at said first location; and
(c) comparing such information read at said first location with said first control subportion;
thereby to ensure the integrity of said command instruction.

2. The method of claim 1 wherein said device array comprises a plurality of ATA devices.

3. The method of claim 1 wherein said device comprises an ATA device register, and wherein said first location is said device register.

4. The method of claim 1 wherein said device comprises a CYLINDER HIGH register, a CYLINDER LOW register, a SECTOR NUMBER register, a FEATURES register and a SECTOR COUNT register, and wherein said first location is one of said registers.

5. The method of claim 1, further comprising the step of:
terminating such command instruction exchange if said first control subportion is not equal to such stored information with which it is compared.

6. The method of claim 1, further comprising the step of:
writing said command portion to a second location on said device;
whereby said device begins executing said command instruction.

7. The method of claim 6 wherein said device comprises a COMMAND register, and wherein said second location is said COMMAND register.

8. The method of claim 6, further comprising the step of:
terminating such command instruction exchange if such execution is not completed within a preset time interval.

9. The method of claim 6 wherein information is stored at a third location and a fourth location on said device, further comprising the steps of:
(a) reading the information stored at said third location on said device;
(b) reading the information stored at said fourth location on said device; and
(c) comparing said information stored at said third location with said information stored at said fourth location.

10. The method of claim 9, further comprising the step of:
terminating such command instruction exchange if said information stored at said third location is not equal to said information stored at said fourth location.

11. The method of claim 9 wherein said device comprises a status register and an ALTERNATE STATUS register, and wherein said third location is said ALTERNATE STATUS register.

12. The method of claim 11 wherein said fourth location is said STATUS register.

13. The method of claim 1, further comprising the step of:
terminating such command instruction exchange if such command instruction exchange does not complete execution within a preset time interval.

14. The method of claim 1 wherein steps (a), (b) and (c) are performed sequentially.

15. The method of claim 1 wherein said ATA device is a disk drive.

16. The method of claim 1 wherein said ATA device is a CD-ROM drive.

17. The method of claim 1 wherein said ATA device is a CD recorder.

18. The method of claim 1 wherein said ATA device is a DVD drive.

19. The method of claim 1 wherein said ATA device is a tape drive.

20. The method of claim 1 wherein said ATA device is a removable floppy drive.

21. A method of ensuring the integrity of a command instruction exchanged between a host system or device and an ATA device of a device array, said command instruction comprising a control portion having a plurality of control subportions and a command portion, comprising the steps of:
(a) writing a first control subportion to a first location on said device;
(b) reading the information stored at said first location;
(c) comparing such information read at said first location with said first control subportion;
(d) writing a second control subportion to a second location on said device;
(e) reading such information stored at said second location; and
(f) comparing such information read at said second location with said second control subportion;
thereby to ensure the integrity of said command instruction.

22. The method of claim 21 wherein said device array comprises a plurality of ATA devices.

23. The method of claim 21 wherein said device comprises a plurality of ATA device registers, and wherein said locations comprise a corresponding plurality of ATA device registers.

24. The method of claim 21 wherein said device comprises a DEVICE/HEAD register, and wherein said first location is said DEVICE/HEAD register.

25. The method of claim 21 wherein said device comprises a CYLINDER HIGH register, CYLINDER LOW register, a SECTOR NUMBER register, a FEATURES register and a SECTOR COUNT register, and wherein said second location is one of said registers.

26. The method of claim 21 wherein the location to which the last control subportion is written is not the first location read.

27. The method of claim 21 wherein steps (a), (b) and (c) are performed sequentially, and wherein steps (a), (b) and (c) are performed before steps (d), (e) and (f).

28. The method of claim 21 wherein steps (a), (b), (c), (d), (e) and (f) are performed sequentially.

29. The method of claim 21, further comprising the step of:
terminating such command instruction exchange if any control subportion is not equal to such stored information with which it is compared.

30. The method of claim 21, further comprising the step of:
terminating such command instruction exchange if such command instruction exchange does not complete execution within a preset time interval.

31. The method of claim 21, further comprising the step of:
writing said command portion to a third location on said device;
whereby said device begins executing said command instruction.

32. The method of claim 31 wherein said device comprises a COMMAND register, and wherein said third location is said COMMAND register.

33. The method of claim 31, further comprising the step of:
terminating such command instruction exchange if such execution is not completed within a preset time interval.

34. The method of claim 31 wherein information is stored at a fourth location and a fifth location on said device, further comprising the steps of:
(a) reading the information stored at said fourth location on said device;
(b) reading the information stored at said fifth location on said device; and
(c) comparing said information stored at said fourth location with said information stored at said fifth location.

35. The method of claim 34, further comprising the step of:
terminating such command instruction exchange if said information stored at said fourth location is not equal to said information stored at said fifth location.

36. The method of claim 34 wherein said device comprises a STATUS register and an ALTERNATE STATUS register, and wherein said fourth location is said ALTERNATE STATUS register.

37. The method of claim 36 wherein said fifth location is said STATUS register.

38. The method of claim 21 wherein said ATA device is a disk drive.

39. The method of claim 21 wherein said ATA device is a CD-ROM drive.

40. The method of claim 21 wherein said ATA device is a CD recorder.

41. The method of claim 21 wherein said ATA device is a DVD drive.

42. The method of claim 21 wherein said ATA device is a tape drive.

43. The method of claim 21 wherein said ATA device is a removable floppy drive.

44. A method of ensuring the integrity of a command instruction exchanged between a host system or device and an ATA device of a device array, said command instruction comprising a control portion having a plurality of control subportions and a command portion, comprising the steps of:
(a) writing a first control subportion to a first location on said device;
(b) reading the information stored at said first location;
(c) comparing such information read at said first location with said first control subportion;
(d) writing a second control subportion to a second location on said device;
(e) writing a third control subportion to a third location on said device;
(f) reading such information stored at said second location; and
(g) comparing such information read at said second location with said second control subportion;
(h) reading such information stored at said third location; and
(i) comparing such information read at said third location with said third control subportion;
thereby to ensure the integrity of said command instruction.

45. The method of claim 44 wherein said device array comprises a plurality of ATA devices.

46. The method of claim 44 wherein said device comprises a plurality of ATA device registers, and wherein said locations comprise a corresponding plurality of ATA device registers.

47. The method of claim 44 wherein said device comprises a DEVICE/HEAD register, and wherein said first location is said DEVICE/HEAD register.

48. The method of claim 44 wherein said device comprises a CYLINDER HIGH register, CYLINDER LOW register, a SECTOR NUMBER register, a FEATURES register and a SECTOR COUNT register, and wherein said second location is one of said registers.

49. The method of claim 48 wherein said third location is another one of said register.

50. The method of claim 44 wherein the location to which the last control subportion is written is not the first location read.

51. The method of claim 44 wherein steps (a), (b) and (c) are performed before steps (d), (e), (f), (g), (h) and (i).

52. The method of claim 44 wherein steps (a), (d) and (e) are performed sequentially and wherein at least one of said first location and said second location is read before said third location is read.

53. The method of claim 44 wherein steps (d) and (e) are performed before steps (f) and (h).

54. The method of claim 44 wherein said command instruction is queued and wherein said device comprises a FEATURES register and a SECTOR COUNT register, and wherein said second location is said FEATURES register and said third location is said SECTOR COUNT register.

55. The method of claim 44, further comprising the step of:
terminating such command instruction exchange if any control subportion is not equal to such stored information with which it is compared.

56. The method of claim 44, further comprising the step of:
terminating such command instruction exchange if such command instruction exchange does not complete execution within a preset time interval.

57. The method of claim 44, further comprising the step of:
writing said command portion to a fourth location on said device;
whereby said device begins executing said command instruction.

58. The method of claim 57 wherein said device comprises a COMMAND register, and wherein said fourth location is said COMMAND register.

59. The method of claim 57, further comprising the step of:
terminating such command instruction exchange if such execution is not completed within a preset time interval.

60. The method of claim 57 wherein information is stored at a fifth location and a sixth location on said device, further comprising the steps of:
(a) reading the information stored at said fifth location on said device;
(b) reading the information stored at said sixth location on said device; and
(c) comparing said information stored at said fifth location with said information stored at said sixth location.

61. The method of claim 60, further comprising the step of:
terminating such command instruction exchange if said information stored at said fifth location is not equal to said information stored at said sixth location.

62. The method of claim 60 wherein said device comprises a STATUS register and an ALTERNATE STATUS register, and wherein said fifth location is said ALTERNATE STATUS register.

63. The method of claim 62 wherein said sixth location is said STATUS register.

64. The method of claim 44 wherein said ATA device is a disk drive.

65. The method of claim 44 wherein said ATA device is a CD-ROM drive.

66. The method of claim 44 wherein said ATA device is a CD recorder.

67. The method of claim 44 wherein said ATA device is a DVD drive.

68. The method of claim 44 wherein said ATA device is a tape drive.

69. The method of claim 44 wherein said ATA device is a removable floppy drive.
